(19) United States
(12) Patent Application Publication
(10) Pub. No.: US 2003/0040948 A1
(43) Pub. Date: Feb. 27, 2003

(54) Quality control method, quality control support system and trend management program for manufacturing operation

(76) Inventor: Mitsuo Sakaguchi, Kariya-shi (JP)

Correspondence Address: FLYNN, THIEL, BOUTELL & TANIS, P.C., 2026 Rambling Road, Kalamazoo, MI, 49008-1699, US

(21) Appl. No.: 10/106,170

(22) Filed: Mar. 26, 2002

(30) Foreign Application Priority Data
Mar. 29, 2001 (JP) 2001-95818

(51) Int. Cl. G06F 17/60

(52) U.S. Cl. 705/7; 705/29; 702/34

(57) ABSTRACT

A product quality control method for a manufacturing operation comprising: storing part-by-part data related to equipment used in a manufacturing process in a storage device using an inputting device; outputting the stored data from the storage device via a processing device to an outputting device as a quality maintenance matrix; measuring characteristic values of a product manufactured by implementing an inspection and manufacturing operation based on the quality maintenance matrix, and additionally storing the obtained characteristic values in the quality maintenance matrix; performing factor analysis on a part related to the quality characteristic item showing an impermissible characteristic value in the above measurement and setting new conditions so as to improve the impermissible characteristic values and storing the quality maintenance matrix revised by the newly set conditions; implementing an inspection and manufacturing operation based on the thus revised quality maintenance matrix prepared in the first step.

### BACKGROUND OF THE INVENTION

1. Field of the Invention

The present invention relates to product quality control in a manufacturing operation, and more particularly to a quality control method and quality control support system for maintaining and improving a product quality control system in a manufacturing operation using a quality control matrix prepared by a unique method.

2. Description of the Prior Art

In the past, in most cases, an ex post facto control system (a system, which stemmed the outflow of defective products by checking the quality of finished products) was employed for managing products in the manufacturing industry, the causal relationship between equipment trouble and poor product quality was unclear, and although it was possible to reduce the outflow of defective products, it was difficult to stop the occurrence of these defects.

Further, there were no clear guidelines regarding the systematic correlation between a maintenance management system and an improvement management system for manufacturing high quality products, and because the maintenance management system and the improvement management system were developed separately, fast, competent quality control could not be devised.

### SUMMARY OF THE INVENTION

A first object of the present invention is to clarify the correlation between quality characteristics and equipment trouble, processing conditions, and the like by using a quality control matrix, and to construct a maintenance management system for equipment that does not produce defective quality products.

A second object is to construct a quality control system capable of detecting all trouble related to defective product quality in a manufacturing process, of quickly and competently analyzing the causal factors therefor using a computer, and of achieving a high level of product quality control while performing daily manufacturing operations via revisions to a quality maintenance matrix.

And a third object is to systematically correlate a maintenance management system and an improvement management system based on fixed characteristic values, to construct an efficient quality control system, and to reduce the production of defective quality products to zero.

A first aspect of the invention is a product quality control method for a manufacturing operation, and is achieved by a product quality control method for a manufacturing operation, the method comprising:

a first step for storing part-by-part data related to equipment used in a manufacturing process in a storage device using an inputting device, and outputting the stored data from the storage device to an outputting device, via a processing device, as a quality maintenance matrix;

a second step for measuring a characteristic value for each quality characteristic item for a product actually manufactured by implementing an inspection and manufacturing operation based on the quality maintenance matrix prepared in the first step, and additionally storing the obtained characteristic value in the quality maintenance matrix stored in the storage device, via the processing device by using the inputting device; and in a case in which some of the characteristic values measured for the product in the second step fall outside a permissible range from a quality standpoint,

a third step for performing factor analysis on a part related to each of the quality characteristic items which exhibit the impermissible characteristic values, setting a new condition such that the characteristic value falls within the permissible range, and storing the quality maintenance matrix revised by setting the new condition, in the storage device using the inputting device; and

a fourth step for maintaining and managing the implementation of an inspection and manufacturing operation based on the quality maintenance matrix revised in the third step.

A second aspect of the invention is a product quality control method for a manufacturing operation, the method comprising:

a first step for storing part-by-part data related to equipment used in a manufacturing process in a storage device using an inputting device, and outputting the stored data from the storage device via a processing device to an outputting device, as a quality maintenance matrix;

a second step for measuring a characteristic value for each quality characteristic item for a product actually manufactured by implementing an inspection and manufacturing operation based on the quality maintenance matrix prepared in the first step, and additionally storing the obtained characteristic value in the quality maintenance matrix stored in the storage device, via the processing device by using the inputting device; and in a case in which all the characteristic values measured for the product in the second step fall within a permissible range from a quality standpoint,

a fourth step for maintaining the implementation of an inspection and manufacturing operation based on the quality maintenance matrix prepared in the first step.

A third aspect of the invention is a product quality control method for a manufacturing operation, the method comprising:

a first step for storing part-by-part data related to equipment used in a manufacturing process in a storage device using an inputting device, and outputting the stored data from the storage device via a processing device to an outputting device, as a quality maintenance matrix;

a second step for measuring a characteristic value for each quality characteristic item for a product actually manufactured by implementing an inspection and manufacturing operation based on the quality maintenance matrix prepared in the first step, and additionally storing the obtained characteristic value in the quality maintenance matrix stored in the storage device, via the processing device, by using the inputting device; and in a case in which some of the characteristic values measured for the product in the second step fall outside a permissible range from a quality standpoint,

a third step for performing factor analysis only for a part related to each of the quality characteristic items which exhibit the impermissible characteristic values in the second step, setting a new condition such that the characteristic value falls within the permissible range, and storing the quality maintenance matrix revised by setting the new condition therein, in the storage device using the inputting device; and

a fourth step for implementing an inspection and manufacturing operation based on the quality maintenance matrix prepared in the first step for a part related to each quality characteristic item which exhibits a characteristic value within the permissible range from a quality standpoint, wherein the forth step is performed simultaneously and in parallel with the third step.

A fourth aspect of the invention is a product quality control support system for a manufacturing operation, comprising:

a means for a computer storage device to acquire part-by-part data related to equipment used in a manufacturing process; and

a means for a computer processing device to process the data stored in the storage device and to output the data to outputting device as a quality maintenance matrix, in product quality control for a manufacturing operation

A fifth aspect of the invention is a computer-based trend management program, comprising: arranging measured data of a product in time series; managing a deterioration trend of the product; and issuing a warning to an outputting device when the measured data does not fall within appropriate reference values.

### BRIEF DESCRIPTION OF THE DRAWINGS

FIG. 1 is a conceptual diagram showing the quality control process of the first aspect of the invention.

FIG. 2 is a conceptual diagram showing the quality control process of the second aspect of the invention.

FIG. 3 is a conceptual diagram showing the quality control process of the third aspect of the invention.

FIG. 4 is a schematic view illustrating a grinder used in the example of this invention.

FIG. 5 is a trend management diagram into which quality characteristic values and time series data have been inputted.

### DETAILED DESCRIPTION OF THE PREFERRED EMBODIMENTS

Next, the embodiments of the present invention will be explained by referring to the figures. FIG. 1 is a conceptual diagram showing the steps in the quality control according to the first aspect of the invention.

In the FIG. 1 indicates the first step, 2 indicates the second step, and 3 indicates the third step. Further, the circle “A” on the left side represents a maintenance management system, and the circle “B” on the right side represents an improvement management system. The arrow indicates the flow of the quality control steps.

In the first step, first of all, a process, which has become a particular cause of producing defects, is specified, and the equipment parts being utilized in this process are itemized. Then, the part of the equipment that is affecting quality, inspection items and reference values related to these parts, criteria and standards (control condition items), such as work criteria and manufacturing skill standards that affect quality, and quality characteristic items are clarified. This data is the data required for constructing a maintenance management system, and, as a rule, comprises all data related to quality control regardless of its name. This data can be obtained by using a Pareto diagram, an x-R diagram, a QC (quality control) process table, a process specification, a processing condition chart, and the six Σ method.

For example, by using a Pareto diagram and a processing conditions chart, it is possible to learn the process and equipment part, which result in defective products, and to understand the circumstances of production for each defect producing state, thereby making it possible to specify a trouble spot, where the frequency of the occurrence of defects is high. By so doing, the specified defective part, inspection item and so forth are stored as data in the storage device of a computer or the like by using an inputting device.

Next, a quality maintenance matrix, for which data is extracted as needed via a processing device from among the various data inputted into the storage device, is obtained. By itemizing the processes, parts and/or items to be controlled along the vertical axis, and displaying the inspection items and reference values related to these parts, the criteria and standards (control condition items), such as work criteria and manufacturing skill standards that affect quality, and quality characteristic items along the horizontal axis so as to correspond to each of the aforesaid parts and/or items, this quality maintenance matrix clarifies the relationship between the parts to be controlled in manufacturing equipment, the control conditions and the quality characteristics.

The second step is a process for restoring defects occurring during implementing an inspection and manufacturing process based on the quality maintenance matrix obtained via the first step. Restoration involves inspecting and bringing the processes and/or parts in which defects occurred, to a proper state based on the control conditions specified in the quality maintenance matrix obtained in the first step, and tuning up the system of quality maintenance in line with the initial work criteria.

After the quality maintenance system has been restored to its original proper state in line with the initial control conditions, the defective part, which is still producing defective products, is specified and the circumstances and factors producing these defects are systematically considered for the specified defective part so that an appropriate characteristic values are set in accordance with criteria required from the standpoint of product quality. The thus set characteristic values are values which become the criteria for designating a permissible range for products of high quality. Either a single or a plurality of characteristic values is set in accordance with the quality characteristics of each product.

The third step is a process for thoroughly analyzing the factors which produce the defects in the defective part specified in the second step, studying the results of analysis, doing research for concrete countermeasures, and revising the quality maintenance matrix prepared by the first step, based on new work criteria, manufacturing skill standards and quality characteristic values obtained as a result thereof.

Analysis of product defect producing factors is performed by differentiating parts in which process defects are numerous, using a Pareto diagram, preparing a simple structural chart for such a part causing numerous process defects, further subdividing this part by unit, clarifying the unit, which is not performing its function, and with regard to the unit that is not performing its function, further inspecting the subassemblies, which make up this unit. If the product defect producing factor is specified as a result of this, it becomes possible to improve the part, which is the defect producing source, and to eradicate process defect caused by this defective part.

When the defect producing source has been improved, a new working criteria chart is prepared to maintain this improved state. After continuing inspection work based on the new working criteria, the quality maintenance matrix prepared by the first step can be revised by preparing a new Pareto diagram, QC process table, x-R diagram and so forth.

The fourth step is a process for implementing and maintaining an actual inspection work and manufacturing operation based on the revised quality maintenance matrix.

Furthermore, quality characteristic items, which should be subjected to trend management, are extracted from the revised quality maintenance matrix, and a trend management diagram, into which product data has been inputted in time series, is prepared. This diagram is prepared to write measurement values in according to a determined cycle, so that a deterioration trend is perceived, and, in addition, defect production is predicted. Therefore, appropriate preventive measures can be taken in advance so as to maintain “zero defects”. A trend management program, which is the invention related to the fifth aspect of this invention, can also be utilized at this time.

After carrying out daily inspection work according to the fourth step, the above-mentioned quality control method is repeated once again by returning again to the first step, effectively using the revised quality maintenance matrix. By repeating the quality control method like this, it is possible to enhance the level of quality in a spiral-like fashion.

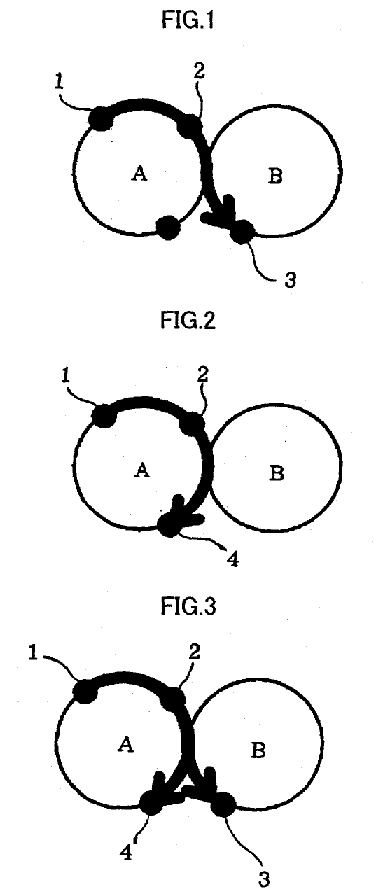

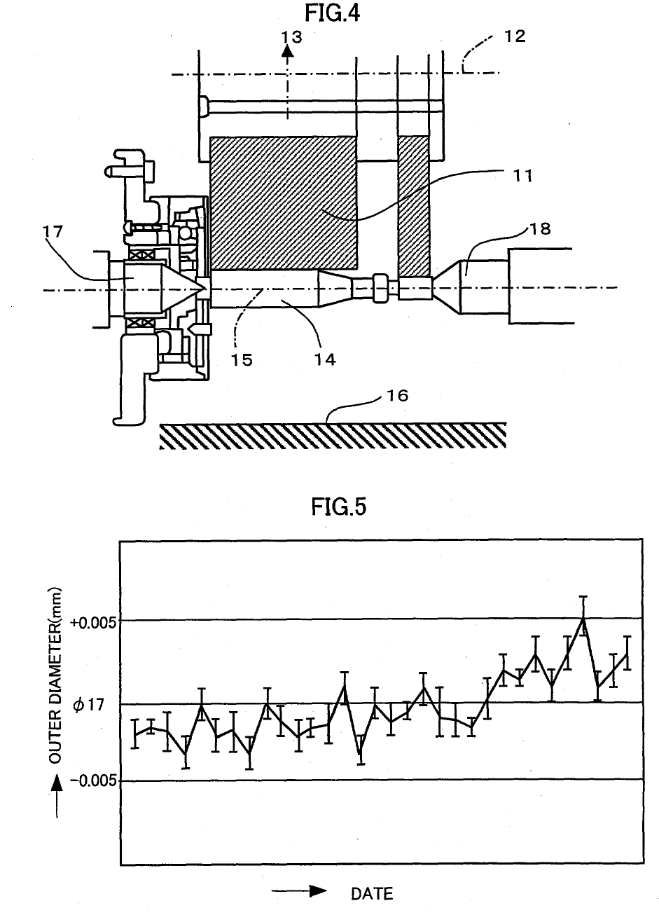

FIG. 2 is a conceptual diagram showing quality control steps according to the aforementioned second aspect of the present invention. In the FIG. 4 represents the fourth step, and the rest is the same as FIG. 1.

The first step and the second step are the same as the steps in the first aspect of the invention.

When all of the characteristic values of the product measured in the second step fall within a permissible range from the standpoint of quality, this indicates that a serious process defect does not exist. Since there are no obstacles whatsoever to continuing the current maintenance management system, the fourth step can be carried out without going through the third step.

The fourth step is a process for implementing actual inspection work and manufacturing operation based on the quality maintenance matrix prepared by the first step.

After carrying out daily inspection work according to the fourth step, the above-mentioned quality control method is repeated once again by returning again to the first step.

FIG. 3 is a conceptual diagram showing quality control steps according to the above-mentioned third aspect of the invention. The first step and the second step are the same as described in the first aspect of the invention.

When in the second step a product is manufactured by implementing an inspection and manufacturing process in accordance with the quality maintenance matrix prepared in the first step and a portion of the characteristic values of the manufactured product does not fall within a permissible range from the standpoint of quality, the third step is taken only for the parts related to the impermissible characteristic values thereof. The third step is a process for thoroughly analyzing the production factors of defects being produced by this part, studying the results of analysis, doing research for concrete countermeasures, and revising only the parts in the quality maintenance matrix prepared by the first step, based on new work criteria, manufacturing skill standards and quality characteristic values obtained as a result thereof.

Analysis of product defect production factors is performed by differentiating parts in which process defects are numerous, for example using a Pareto diagram, preparing a simple structural chart for the part having numerous process defects, further subdividing this part by unit, clarifying the unit, which is not performing its function, and with regard to the unit that is not performing its function, further inspecting the subassemblies, which make up this unit. If the production factor is specified as a result of this, it becomes possible to improve the defect production source thereof, and to eradicate the process defects caused by this part.

When the defect production source has been improved, a new working criteria sheet is prepared to maintain this improved state. After continuing inspection work based on the new working criteria, the quality maintenance matrix prepared by the first step can be revised by preparing a new Pareto diagram, QC process table, x-R diagram and so forth.

Conversely, when some of the characteristic values of the product measured in the second step fall within a permissible range from the standpoint of quality, this indicates that a serious process defect does not exist in the part related to this quality characteristic item, and since the current maintenance management system can be continued for this part, the fourth step can be proceeded without going through the third step for this part.

Therefore, in this third aspect of the present invention, implementation of the third step and the fourth step proceeds simultaneously and in parallel.

As mentioned above, whether the fourth step is carried out after carrying out the third step or without the third step is determined for every part depending on whether the characteristic value related to the part is outside or within the permissible range from the standpoint of quality. In such a manner, maintenance and management are simultaneously advanced and it is possible to systematically correlate a maintenance management system and an improvement management system, and to construct an efficient overall quality control system.

The invention fourth aspect of the invention is a product quality control support system for a manufacturing operation, characterized in that it comprises a means for a computer storage device to acquire part-by-part data related to equipment used in a manufacturing process; and a means for a computer processing device to process the data stored in the storage device and to output the data to outputting device as a quality maintenance matrix, in product quality control for a manufacturing operation.

A defect-producing process, which has become a particular source of product defects, is specified within an overall manufacturing process, and the equipment being utilized in this process is identified. Then, the part of the equipment that is affecting quality, inspection items and reference values related to this part, criteria and standards regarding process specification and manufacturing skills, etc., which affect quality, and quality characteristic items are clarified. This data is the data required for constructing a maintenance management system, and, as a rule, comprises all data related to quality control regardless of its name.

This data is stored in a computer storage device using an inputting device. Next, a quality maintenance matrix is obtained via a processing device.

The fifth aspect of the invention is a computer-based trend management program, characterized in that it arranges product quality characteristic values and measured data in time series, manages a product quality deterioration trend, and generates a warning to an outputting device when measured data does not fall within appropriate reference values.

Data inputted into the program is physical data, such as the outer diameter dimensions of a product. Such data is measured at fixed periods, and stored in a computer.

The characteristic values of the quality maintenance matrix are stored in the program so that assessment can be made as to whether or not newly inputted data falls within the permissible range of these characteristic values. When data is outside the permissible range, a display urging caution is displayed on a display device such as a display or a printer.

When a warning has been issued, the items to be periodically inspected in the quality maintenance matrix are revised.

Further, there are also cases in which the revision of the inspection cycle is carried out by analyzing the trends of inputted data.

### EXAMPLE

The embodiment according to the third aspect of the invention will be explained hereinbelow giving as an example a case in which a outer diameter dimension defect occurs in a grinding process.

FIG. 4 is a schematic view illustrating a grinder used in this example. In the figure, there are shown a grinding wheel 11, a grinding wheel spindle 12, a grinding wheel slide axis 13, a work (a shaft having a circular cross-section for a vane pump) 14, a center line 15, a support table 16, a main spindle 17 and a tailstock spindle 18.

In a case where defects occurring during the processing step of the work 14, especially during grinding the work, have been recognized, the quality characteristics which are affected by the grinder are made known by carrying out analysis using a Pareto diagram of grinder defects. For example, the defect production frequency for an outer diameter dimension defect and other defect items are specified and defect production factors are clarified. The results of this analysis are stored, by way of the inputting device, as quality characteristic data in the storage device. There are cases in which, depending on the equipment, huge amounts of data is required.

Further, there are also cases in which a quality maintenance process table is prepared for the grinder. Data related to the steps, parts and so forth to be managed are obtained from this table, and these data are stored in the storage device by way of the inputting device. There are cases in which, depending on the equipment, huge amounts of data is required.

Further, there are also cases in which a work criteria table, processing conditions table and the like are prepared. Data related to inspection criteria, the inspection cycle, responsible party and the like are obtained from these tables, and these data are stored in the storage device by way of the inputting device.

Next, the data stored in the storage device is outputted from the storage device by way of the processing device to the outputting device as a quality maintenance matrix. Here, the outputting device refers to a computer display or printer.

Table 1 shows one example of a quality maintenance matrix obtained by the above-mentioned first step. In Table 1, the mark “o” is shown in the columns with the heading “Maintenance and Management” and “Quality Characteristic Item” to indicate the inspection part (“Part to be inspected”) related to each item listed in the above columns. Further, “Center Deviation” is a deviation of the centers of the work 14 at its both ends from the predetermined centerline 15. The same is applied to other tables.

TABLE 1

| | Equipment-Jigs-Machines | | | | | | | | Quality Characteristics Items | | |
|---|---|---|---|---|---|---|---|---|---|---|---|
| | | | | | | Responsi- | Maintenance | | Outer | | |
| | | Part to be | Item to be | Reference | Inspection | ble | Management | | Diameter | Round- | |
| Process | | inspected | inspected | Value | Cycle | Party | Daily | Periodically | Variability | ness | Strength |
| Grinding | Grinder | Grinding | Backlash | Within | Once | Maker | | ∘ | ∘ | | ∘ |
| Process | | Wheel Slide | | ±0.01 mm | Every | | | | | | |
| | | Axis | | | 5 months | | | | | | |
| | | Grinding | Micro- | No | Once | Person | | ∘ | | ∘ | |
| | | Wheel | vibration | Micro- | Every | In | | | | | |
| | | Spindle | | vibration | 4 months | Charge | | | | | |
| | | Main | Vibration | No | Twice a | Main- | | ∘ | ∘ | ∘ | |
| | | Spindle | | Vibration | month | tenance | | | | | |
| | | | | | | Staff | | | | | |
| | | Center at | Center | Within | | Leader | | ∘ | ∘ | | |
| | | Both Ends | Deviation | ±0.01 mm | | | | | | | |
| | | Carbide | Wear of | No | | Person | | ∘ | | ∘ | ∘ |
| | | Center | Tip | Chip | | In | | | | | |
| | | | | | | Charge | | | | | |
| | | Center | Pressure | 17-19 | | Person | ∘ | | ∘ | ∘ | |
| | | Clamping | | kg/cm² | | In | | | | | |
| | | Force | | | | Charge | | | | | |
| | | Grinding | Balance | Well | | Leader | | ∘ | | ∘ | ∘ |
| | | Wheel | | Balance | | | | | | | |
| | | Grinding | Grinding | 20 | | Person | | ∘ | ∘ | | |
| | | Time | Time | seconds | | In | | | | | |
| | | | | or | | Charge | | | | | |
| | | | | less | | | | | | | |

By actually performing an inspection work and manufacturing process in accordance with the quality maintenance matrix obtained in the first step, the characteristic value of the product is measured for each quality characteristic item in order to evaluate whether the characteristic value falls within a permissible range from the standpoint of quality. The thus obtained quality characteristic values are added to and stored in the quality maintenance matrix prepared in the first step, by way of the processing device of a computer.

The quality maintenance matrix, to which the quality characteristic value have been added in this second step, is shown in Table 2.

TABLE 2

| | | | | Quality Characteristic Items | | | | | |
|---|---|---|---|---|---|---|---|---|---|
| | | | | Outer | | | | | |
| | | | | Diameter | | | | | |
| | | | | Variability | | | | | |
| Equipment-Jigs-Machines | | | | | Character- | Roundness | | Strength | |
| Part to be | Item to be | Reference | | Related | istic | Related | | Related | Cutting |
| inspected | inspected | Value | . . . | Part | Value | Part | Roundness | Part | Stress |
| Grinding | Backlash | Within | . . . | ∘ | φ17 | | Within | | 10⁵ N/m² |
| Wheel | | ±0.01 mm | | | ±0.005 mm | | ±0.01 mm | | ±0.1 N/m² |
| Slide Axis | | | | | | | | | |
| Grinding | Microvibration | No | . . . | | ∘ | | | | |
| Wheel | | Microvibration | | | | | | | |
| Spindle | | | | | | | | | |
| Main | Vibration | No | . . . | ∘ | | ∘ | | ∘ | |
| Spindle | | Vibration | | | | | | | |
| Centers at | Center | Within | . . . | ∘ | | | | ∘ | |
| Both Ends | Deviation | ±0.01 mm | | | | | | | |
| of Work | | | | | | | | | |
| Carbide | Wear of Tip | No | . . . | | | ∘ | | | |
| Center | | chip | | | | | | | |
| Center | Pressure | 17-19 kg/cm² | . . . | ∘ | | ∘ | | ∘ | |
| Clamping | | | | | | | | | |
| Force | | | | | | | | | |
| Grinding | Balance | Well | . . . | | | ∘ | | | |
| Wheel | | Balance | | | | | | | |
| Grinding | Grinding | 20 seconds | . . . | ∘ | | | | | |
| Time | Time | or less | | | | | | | |

With respect to parts related to quality characteristic items indicating numerical characteristic values outside the permissible ranges, the causal factor analysis is conducted on these parts.

For example, when due to a change in the grinding wheel slide axis, the outer diameter of the ground work (shaft) exceeds the permissible range (±0.005mm) of the quality characteristic value and becomes coarse, the third step is conducted and the defect production factor thereof is thoroughly analyzed.

A PM (preventive maintenance) analysis table is mainly used for this analysis. In the PM analysis, the defective symptom is one in which a defect event is physically analyzed according to principles and rules, the mechanism of the defective symptom is clarified, and all factors which are logically considered to have an influence thereon are listed up from the aspects of equipment structure, materials, and the like, and brought together in a table. For example, Table 3 shows one such example.

TABLE 3

| Part to be | Item to be | Inspection | Responsible | |
|---|---|---|---|---|
| inspected | inspected | Cycle | Party | Countermeasure or Action |
| Grinding | Backlash | Once | Person | Adjustment of pulse while measuring a big dial |
| Wheel | | Every | In | |
| Slide Axis | | 2 months | Charge | |
| Centers at | Center | | Leader | Preparation of a model, and measurement and correction |
| Both Ends | Displace- | | | of vibration |
| | ment | | | |
| Carbide | Wear of | | Person | Measurement of wear damage |
| Center | Tip | | In | |
| | | | Charge | |
| Grinding | Balance | Twice a | Leader | Visual measurement of vibration |
| Wheel | | month | | |
| | Size | Once a | Person | Measurement of size, and maintenance of peripheral |
| | (Additional | month | In | speed according to size |
| | item) | | Charge | |

Based on the results of such analysis, at times restoration work is carried out together with the tool manufacturer. For example, with regard to the change of a work center line, it was determined that the defect production factors were poor grinding fluid coverage, and an irregular amount of grinding fluid dispensed from a plurality of nozzles. As a countermeasure to this, flow regulating valves were mounted to all the nozzles, and this defect was corrected.

When a quality defect is not improved even after the above-described restoration work has been completed, thoroughgoing PM analysis is repeated until the defect production factor becomes clear. When a defect production factor has been specified, concrete improvement measures are reviewed, and the quality maintenance matrix obtained by the first step is revised based on a new inspection cycle, permissible values, and quality characteristics and inspection method. Table 4 shows a revised quality maintenance matrix.

TABLE 4

| | | | | | | | | | | Quality | |
|---|---|---|---|---|---|---|---|---|---|---|---|
| | | | | | | | | | | Characteristic | |
| | | | | | | | | | | Item | |
| | | | | | | | | | | Outer | |
| | | | | | | | | | | Diameter | |
| | | | | | | | Maintenance | | Counter- | variability | |
| | | Part to be | Item to be | Reference | Inspection | Responsible | Management | | measure | Related | |
| Process | | inspected | inspected | Value | Cycle | Party | Daily | Periodically | or Action | Part | . . . |
| Grinding | Grinder | Grinding | Backlash | Within | Once every | Maker | | ∘ | | ∘ | . . . |
| Process | | Wheel | | ±0.01 mm | 2 months | | | | | | |
| | | Slide Axis | | | | | | | | | |
| | | Grinding | Micro- | No | Once every | Person in | | ∘ | | | |
| | | Wheel | vibration | Micro- | 4 months | Charge | | | | | |
| | | Spindle | | vibration | | | | | | | |
| | | Main | Vibration | No | Twice a | Maintenance | | ∘ | | ∘ | |
| | | Spindle | | Vibration | month | Staff | | | | | |
| | | Centers at | Center | Within | | Leader | ∘ | | | ∘ | |
| | | Both Ends | Deviation | ±0.005 mm | | | | | | | |
| | | Carbide | Wear of | No | | Person in | ∘ | | | | |
| | | Center | Tip | Chip | | Charge | | | | | |
| | | Center | Pressure | 17-19 | | Person in | ∘ | | | ∘ | |
| | | Clamping | | kg/cm² | | Charge | | | | | |
| | | Force | | | | | | | | | |
| | | Grinding | Balance | Well | Twice a | Leader | | ∘ | | | |
| | | Wheel | | Balance | month | | | | | | |
| | | | Size | | Once a | | | ∘ | | | |
| | | | | | month | | | | | | |
| | | Grinding | Grinding | 20 seconds | | Person in | | ∘ | | ∘ | |
| | | Time | Time | or less | | charge | | | | | |

Next, the fourth step is carried out, wherein an actual inspection work and manufacturing operation are performed based on the revised quality maintenance matrix.

In the fourth step, items requiring trend management are extracted from the revised quality maintenance matrix, a trend management diagram, into which characteristic values are written, is prepared, and the standardized conditions of items, for which characteristic values will be revised, are improved.

For example, when trend management is carried out for the outer diameter of the shaft, the quality characteristic value(permissible range within +0.005 to −0.005 mm) for the outer diameter of the shaft set in the second step is extracted from the quality maintenance matrix, and inputted to trend management software as reference value data.

Next, the outer diameter dimensions of the shaft are measured in accordance with an actual sampling inspection, and time series data is obtained by inputting this measured data into the trend management software of a computer. FIG. 5 shows a trend management diagram into which these quality characteristic values and time series data are inputted.

If the obtained time series data falls within the permissible range of the reference values, there are no problems whatsoever from the standpoint of quality, thus indicating the current quality maintenance matrix-based quality control system is good. Conversely, either when the time series data exceeds the permissible range of the reference values inputted into the trend management software, or when there is a tendency to exceed the permissible range of the reference values, since this indicates that a problem has arisen in the management of conditions with respect to the inspection cycle and so forth in the quality control system, a sign indicating a warning against the problem is outputted to a display device of the computer.

After carrying out the work of the fourth step, when no problems whatsoever arise from the standpoint of quality control, the present invention returns to the first step, and repeats the above-mentioned quality control method once again.

The first aspect of the invention, in which a quality maintenance matrix based on fixed parameters (quality characteristic values) is used, makes it possible to greatly reduce the rate of occurrence of defective products by inspecting the equipment, which maybe the causal factor of product defect occurrence, under the specified conditions with respect to the inspection cycle, procedures, etc.

The second aspect of the invention in which the maintenance system is checked without revising the management system, makes it possible to maintain a quality control system while conducting daily operations.

The third aspect of the invention, in which an efficient quality control system is constructed by systematically correlating the maintenance management system and the improvement management system, and further all defects in manufacturing equipment are inspected and the causal factors thereof are analyzed using a computer, makes it possible to construct and maintain a quality control system capable of quickly and reliably implementing product quality control while carrying out daily manufacturing operations.

The fourth aspect of the invention, by competently processing the volume of data using a computer, makes it possible to prepare a quality maintenance matrix in an instant, to clarify the correlation between quality characteristics and items to be inspected, and to construct a high-level quality control system.

The fifth aspect of the invention, by utilizing trend management software, makes it possible to predict defect production in a plurality of parts, to prevent a defect before it happens, and to prepare a further improved quality maintenance matrix.

What is claimed is:

1. A product quality control method for a manufacturing operation, the method comprising:
a first step for storing part-by-part data related to equipment used in a manufacturing process in a storage device using an inputting device, and outputting the stored data from the storage device to an outputting device, via a processing device, as a quality maintenance matrix;
a second step for measuring a characteristic value for each quality characteristic item for a product actually manufactured by implementing an inspection and manufacturing operation based on the quality maintenance matrix prepared in the first step, and additionally storing the obtained characteristic value in the quality maintenance matrix stored in the storage device, via the processing device by using the inputting device; and in a case in which some of the characteristic values measured for the product in the second step fall outside a permissible range from a quality standpoint,
a third step for performing factor analysis on a part related to each of the quality characteristic items which exhibit the impermissible characteristic values, setting a new condition such that the characteristic value falls within the permissible range, and storing the quality maintenance matrix revised by setting the new condition, in the storage device using the inputting device; and
a fourth step for maintaining and managing the implementation of an inspection and manufacturing operation based on the quality maintenance matrix revised in the third step.

2. A product quality control method for a manufacturing operation, said method comprising:
a first step for storing part-by-part data related to equipment used in a manufacturing process in a storage device using an inputting device, and outputting the stored data from the storage device via a processing device to an outputting device, as a quality maintenance matrix;
a second step for measuring a characteristic value for each quality characteristic item for a product actually manufactured by implementing an inspection and manufacturing operation based on the quality maintenance matrix prepared in the first step, and additionally storing the obtained characteristic value in the quality maintenance matrix stored in the storage device, via the processing device by using the inputting device; and in a case in which all the characteristic values measured for the product in the second step fall within a permissible range from a quality standpoint,
a fourth step for maintaining the implementation of an inspection and manufacturing operation based on the quality maintenance matrix prepared in the first step.

3. A product quality control method for a manufacturing operation, said method comprising:
a first step for storing part-by-part data related to equipment used in a manufacturing process in a storage device using an inputting device, and outputting the stored data from the storage device via a processing device to an outputting device, as a quality maintenance matrix;
a second step for measuring a characteristic value for each quality characteristic item for a product actually manufactured by implementing an inspection and manufacturing operation based on the quality maintenance matrix prepared in the first step, and additionally storing the obtained characteristic value in the quality maintenance matrix stored in the storage device, via the processing device, by using the inputting device; and in a case in which some of the characteristic values measured for the product in the second step fall outside a permissible range from a quality standpoint,
a third step for performing factor analysis only for a part related to each of the quality characteristic items which exhibit the impermissible characteristic values, setting a new condition such that the characteristic value falls within the permissible range, and storing the quality maintenance matrix revised by setting the new condition therein, in the storage device using the inputting device; and
a fourth step for implementing an inspection and manufacturing operation based on the quality maintenance matrix prepared in the first step for a part related to each quality characteristic item which exhibits a characteristic value within the permissible range from a quality standpoint, wherein the forth step is performed simultaneously and in parallel with the third step.

4. A product quality control support system for a manufacturing operation, comprising:
a means for a computer storage device to acquire part-by-part data related to equipment used in a manufacturing process; and
a means for a computer processing device to process the data stored in the storage device and to output the data to outputting device as a quality maintenance matrix, in product quality control for a manufacturing operation.

5. A computer-based trend management program, comprising:
arranging measured data of a product in time series;
managing a deterioration trend of the product; and
issuing a warning to an outputting device when the measured data does not fall within appropriate reference values.
